(19) United States
(12) Patent Application Publication
(10) Pub. No.: US 2009/0267939 A1
(43) Pub. Date: Oct. 29, 2009

(54) INPUT DEVICE OF COMPUTER SYSTEM AND METHOD FOR OPERATING COMPUTER SYSTEM

(75) Inventors: Chin-Chung Kuo, Taipei (TW); Yih-Chieh Pan, Taipei (TW); Yen- Ko Chiang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/365,173

(22) Filed: Feb. 4, 2009

(30) Foreign Application Priority Data
Apr. 23, 2008 (TW) 97114894

(51) Int. Cl. G06T 15/00

(52) U.S. Cl. 345/419

(57) ABSTRACT

An input device of a computer system and a method for operating the computer system are provided. In the method for operating the computer system, a motion state of the input device in three-dimensional space is detected first. Then, a predetermined code is generated at an operation terminal or a main body terminal of the computer system according to the motion state of the input device. Afterwards, the predetermined code is converted to a corresponding object code, and the object code is sent to the main body terminal of the computer system to make the computer system operate according to the object code.

### CROSS-REFERENCE TO RELATED APPLICATION

This application claims the priority benefit of Taiwan application serial no. 97114894, filed on Apr. 23, 2008. The entirety of the above-mentioned patent application is hereby incorporated by reference herein and made a part of specification.

### BACKGROUND OF THE INVENTION

1. Field of the Invention

The invention relates to an input device of a computer system and, more particularly, to an input device of the computer system and a method for operating the computer system utilizing a motion state of a user in three-dimensional space as input.

2. Description of the Related Art

Conventional input devices of a computer system include a keyboard, a mouse, and a touch pad. A user may press keys on the keyboard to input data, and he or she also may operate the computer system by his or her two-dimensional motion on the mouse or touch pad.

However, in some special situations such as playing computer games, the conventional input devices cannot provide a more convenient input mode. Therefore, many special input devices such as joysticks are invented. Although the special input devices can make operations of the computer games more interesting, they still cannot make users operate the computer games intuitively.

In addition, since data are inputted to the computer system by a conventional input device in a constant mode, the users cannot define the mode according to their likes or requirements. For example, when playing the computer games, the users can only use a keyboard or a mouse to operate the computer games, and they cannot use a hand-held input device used in space to communicate with the computer by postures or motions. Therefore, the conventional input devices cannot satisfy requirements of the advanced users.

### BRIEF SUMMARY OF THE INVENTION

One objective of the invention is to provide an input device of a computer system and a method for operating the computer system.

The invention provides a method for operating a computer system. First, a motion state of an operation terminal in three-dimensional space is detected, and a predetermined code is generated at the operation terminal or a main body terminal of the computer system according to the motion state of the operation terminal in the three-dimensional space. Moreover, the predetermined code is converted to a corresponding object code, and the object code is sent to the main body terminal of the computer system to make the computer system operate according to the object code.

In another aspect, the invention provides an input device adapted for operating a main body terminal of a computer system. The input device includes a motion sensor, a receiver, and an interface unit. The motion sensor is used to detect a motion state of the input device in three-dimensional space to output original sensing data. The receiver is used to receive the original sensing data and generate a corresponding predetermined code according to the original sensing data. The interface unit is used to convert the predetermined code to a corresponding object code and send the object code to the main body terminal of the computer system to make the computer system operate according to the object code.

In the invention, the predetermined code of the input device is converted to the object code via the interface unit to make the computer system operate according to the object code. Therefore, the input device is used to execute different kinds of operating instructions of the computer system, and corresponding operating modes are set in light of different applications, which is more visual, real and unlimited for users to operate the computer system.

These and other features, aspects, and advantages of the present invention will become better understood with regard to the following description, appended claims, and accompanying drawings.

### BRIEF DESCRIPTION OF THE DRAWINGS

FIG. 1 is a block diagram of a computer system according to a first embodiment of the invention;

FIG. 2 is a block diagram of an interface unit according to the first embodiment of the invention;

FIG. 3 is a flowchart of a method for operating the computer system according to the first embodiment of the invention;

FIG. 4A is a top view of a motion sensor according to the first embodiment of the invention;

FIG. 4B is a side view of the motion sensor according to the first embodiment of the invention;

FIG. 5 and FIG. 6 are flowcharts of a method for generating a predetermined code according to the first embodiment of the invention;

FIG. 7 is a flowchart of a method for setting an object code according to the first embodiment of the invention;

FIG. 8 is a block diagram of a computer system according to a second embodiment of the invention;

FIG. 9 is a block diagram of an interface unit according to the second embodiment of the invention; and

FIG. 10 is a flowchart of a method for operating the computer system according to the second embodiment of the invention.

### DETAILED DESCRIPTION OF THE EMBODIMENTS

### First Embodiment

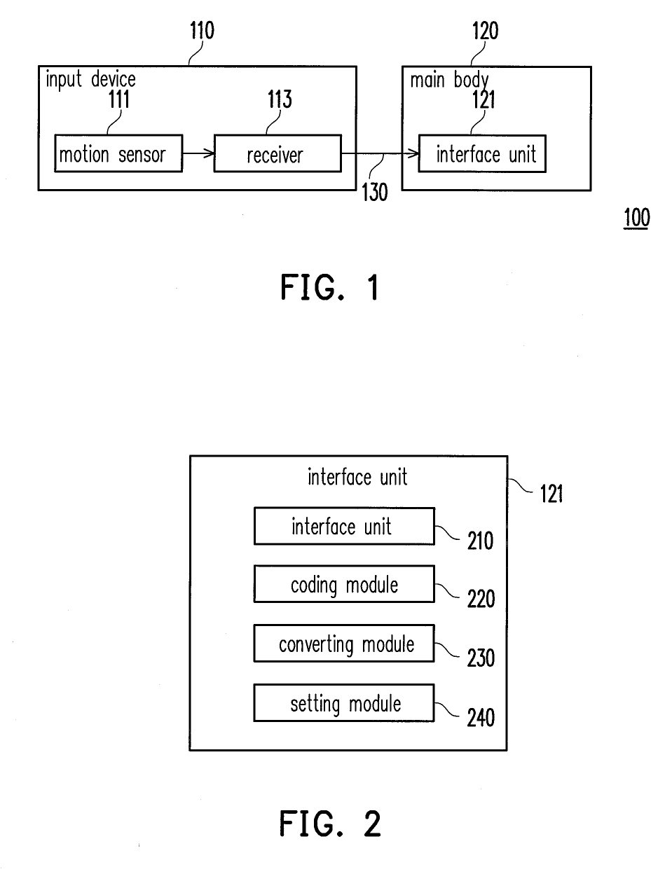

FIG. 1 is a block diagram of a computer system according to the first embodiment of the invention. As shown in FIG. 1, a computer system 100 includes an input device 110 and a main body terminal 120. In the embodiment, the input device 110 is coupled with the main body terminal 120 via a transmission interface 130. The input device 110 includes a motion sensor 111 and a receiver 113, and the main body terminal 120 includes an interface unit 121. In the embodiment, the transmission interface 130 is a universal serial bus (USB) interface. In other embodiments, the transmission interface 130 may be an institution of electrical and electronics engineers (IEEE) 1394, a serial interface, a parallel interface, or a personal computer memory card international association (PCMCIA).

The input device 110 is used to output original sensing data or a predetermined code according to a motion state in three-dimensional space. In detail, the input device 110 detects its own motion state in the three-dimensional space via the motion sensor 111 to output the original sensing data to the receiver 113. The receiver 113 may directly transfer the original sensing data to the main body terminal 120, or after a corresponding predetermined code is generated according to the original sensing data, the receiver 113 sends the predetermined code to the main body terminal 120.

In the embodiment, the receiver 113 is a portable micro electronic device, and it may be inserted to a transmission connector (such as the transmission interface 130) of the main body terminal 120. In the embodiment, the motion sensor 111 transfers the original sensing data to the receiver 113 by a wireless mode.

In the embodiment, the original sensing data are a coordinate position of the input device 110 in the three-dimensional space, gravitation data of the input device 110 in the motion state, or a relative position of the input device 110 in moving in the three-dimensional space. In the embodiment, the predetermined codes such as ASCII codes correspond to different motion states of the input device 110.

For example, the motion state of the input device 110 includes waving upward, waving downward, waving left, waving right and so on. The direction toward which the input device 110 is waved is recognized according to the original sensing data such as the coordinate position, the gravitation data and the relative positions in moving. Therefore, the original sensing data are coded to be predetermined codes to represent motions of waving the input device 110 toward different directions.

In addition, the interface unit 121 of the main body terminal 120 receives the original sensing data or the predetermined code transferred from the input device 110 via the transmission interface 130, and the original sensing data or the predetermined code is converted to the corresponding object code to make the computer system 100 operate. In the embodiment, the object code corresponds to an operating motion performed in the computer system 100. The operating motion is, for example, to click a left button of a mouse.

Components of the interface unit 121 are described in detail hereinbelow. FIG. 2 is a block diagram of the interface unit according to the first embodiment of the invention. As shown in FIG. 2, in the embodiment, the interface unit 121 is a computer program installed on the main body terminal 120, which is only used to facilitate the description instead of limiting the scope of the invention.

The interface unit 121 includes a collecting module 210, a coding module 220, a converting module 230, and a setting module 240. The collecting module 210 is used to receive the original sensing data or the predetermined code sent from the input device 110. The coding module 220 is used to code the original sensing data to generate the predetermined code. The converting module 230 is used to convert the predetermined code to a corresponding object code. The setting module 240 is used to receive operation of a user to change the predetermined code that the object code corresponds to, and it is used to provide a file list showing a plurality of data options for the user to select. According to the selection of the user, the predetermined code to which the object code corresponds is automatically set.

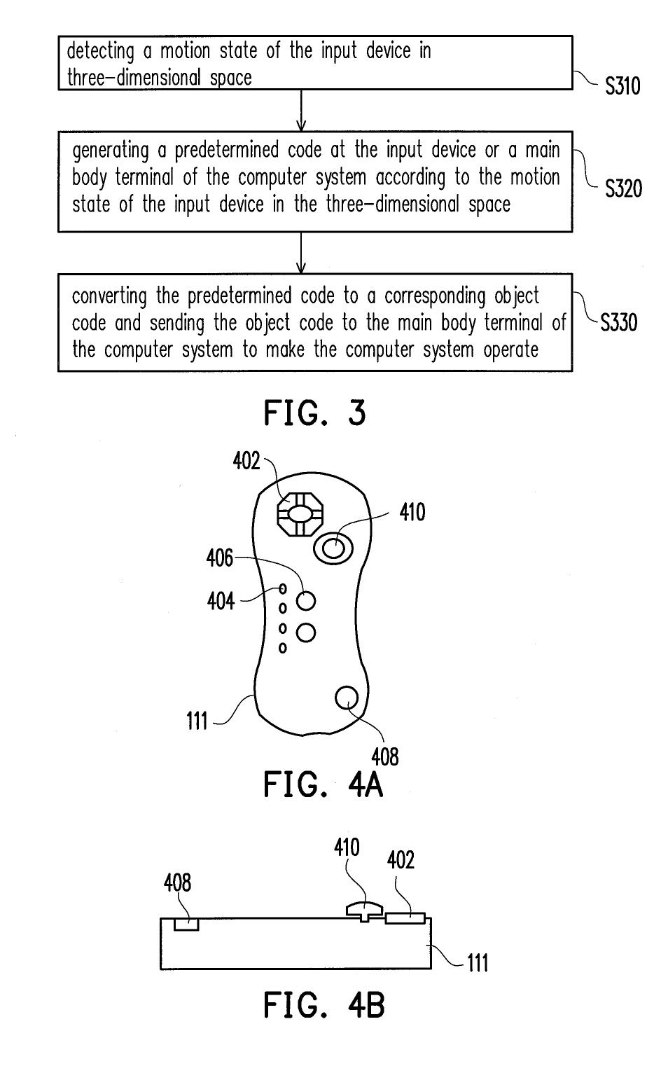

The steps of the method for operating the computer system in the first embodiment are described in detail with the computer system 100 hereinbelow. FIG. 3 is a flowchart of the method for operating the computer system according to the first embodiment of the invention. As shown in FIG. 1, FIG. 2 and FIG. 3, first, in step S310, the motion sensor 111 detects the motion state of the input device 110 in the three-dimensional space. For example, a user waves the input device 110 upward.

Afterwards, in step S320, according to the motion state of the input device 110 in the three-dimensional space, a predetermined code is generated at the output device 110 or the main body terminal 120. The input device 110 may further have a plurality of function keys and a joystick input interface to cooperate with the motion state of the input device 110 in the three-dimensional space to generate more usage modes.

For example, FIG. 4A is a top view of a motion sensor according to the first embodiment of the invention. FIG. 4B is a side view of the motion sensor according to the first embodiment of the invention. As shown in FIG. 4A and FIG. 4B, the motion sensor 111 may have a plurality of function keys 402, 404, 406 and 408. The function key 402 may be a four directional key, and the function key 408 may be a power key. A joystick 410 may be disposed on the motion sensor 111. When different function keys are pressed, the motion sensor 111 is correspondingly operated. For example, when the function key 404 is enabled (pressed), it represents that power of the motion sensor 111 is turned on.

The function keys 402 to 408 and the joystick 410 may correspond to a predetermined code, or they cooperate with motion states of the input device 110 to correspond to a predetermined code. It depends on a usage condition. A corresponding relationship between the predetermined code and the input device 110 may be preset by manufactures or determined by users. It is not limited herein.

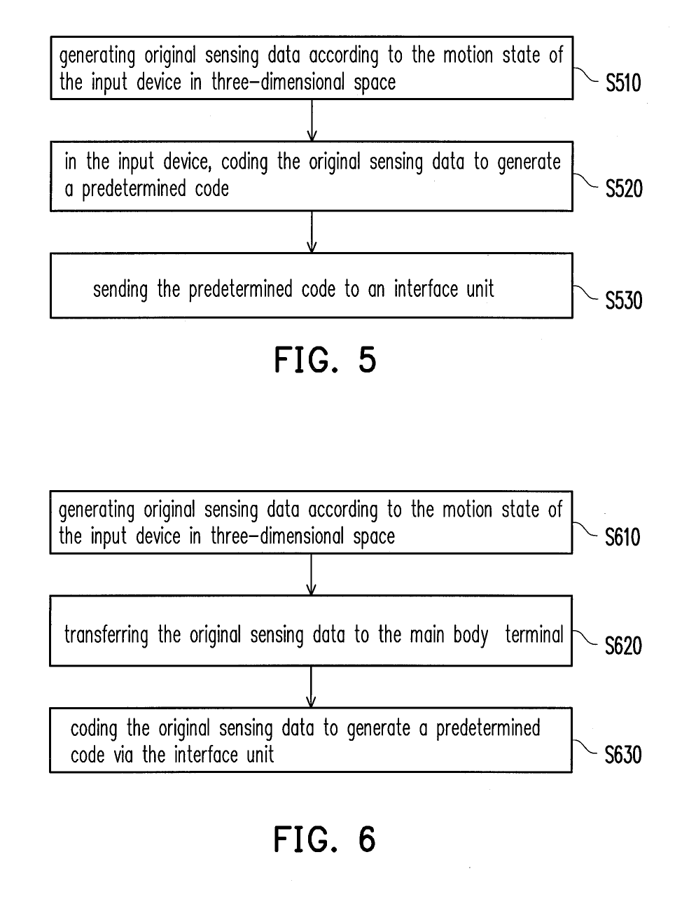

The detailed steps of generating a predetermined code in the input device 110 and the main body terminal 120 are described hereinbelow, respectively. FIG. 5 and FIG. 6 are flowcharts of a method for generating a predetermined code according to the first embodiment of the invention. As shown in FIG. 5, in the embodiment, the predetermined code is generated in the input device 110. As stated in step S510, the motion sensor 111 generates original sensing data. Then, in step S520, the motion sensor 111 transfers the original sensing data to the receiver 113 to make the receiver 113 code the original sensing data to generate the predetermined code. Afterwards, as stated in step S530, the receiver 113 further sends the predetermined code to the main body terminal 120 to make the interface unit 121 of the main body terminal 120 convert the predetermined code to an object code.

Afterwards, as shown in FIG. 6, in the embodiment, the predetermined code is generated in the main body terminal 120. As stated in step S610, the motion sensor 111 generates original sensing data and transfers the original sensing data to the receiver 113. Then, in step S620, the receiver 113 directly transfers the original sensing data to the main body terminal 120. Afterwards, as stated in step S630, in the main body terminal 120, when the collecting module 210 of the interface unit 121 receives the original sensing data, it immediately codes the original sensing data to the predetermined code via the coding module 220.

Referring back to FIG. 3, after the predetermined code is generated, as stated in step S330, the converting module 230 of the interface unit 121 converts the predetermined code to a corresponding object code and sends the object code to the main body terminal 120 of the computer system 100 to make the computer system 100 operate according to the object code. For example, the interface unit 121 may provide a convert file to record the predetermined code that the object code corresponds to. The setting of the convert file may be preset by the manufacturers or set by users.

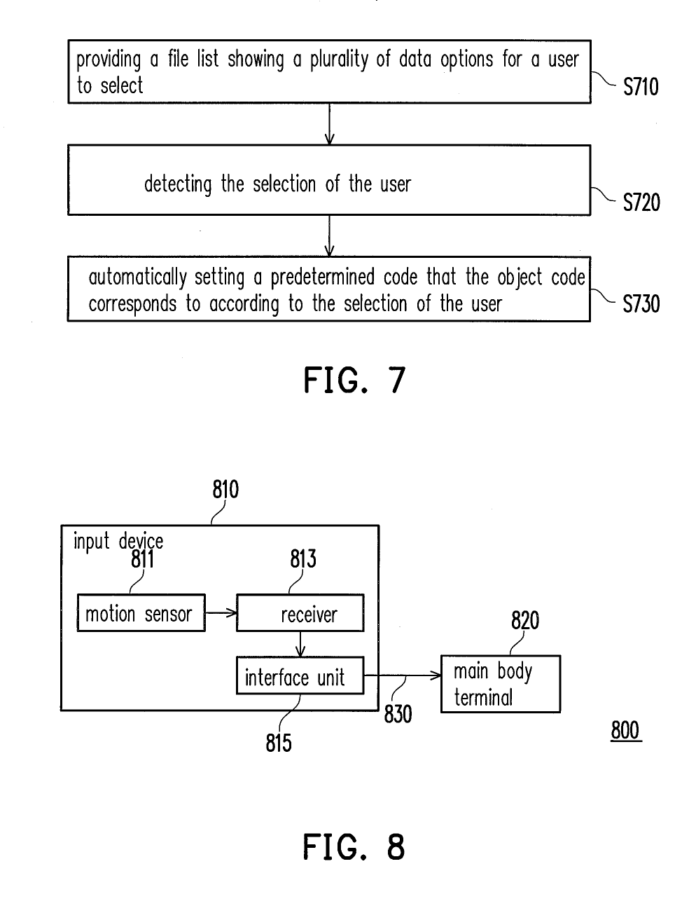

For example, FIG. 7 is a flowchart of a method for setting an object code according to the first embodiment of the invention. As shown in FIG. 1, FIG. 2 and FIG. 7, first, in step S710, a file list is provided via the setting module 240 of the interface unit 121 for a user to select, and it includes many data options. Afterward, as stated in step S720, the setting module 240 detects the selection of the user. At last, in step S730, the setting module 240 automatically sets the predetermined code to which the object code corresponds according to the selection of the user.

The data options are, for example, application options for allowing the user to select the applications needed to be used. That is, the input device 110 has preset the predetermined codes that the object codes of the applications correspond to. Therefore, after the user selects one of the applications, the setting module 240 automatically sets the predetermined code that the object code corresponds to.

Furthermore, the data options also may be the object codes of the motion states of the input device 110 for the user to set. After the user selects the object code that the motion state corresponds to, the setting module 240 builds a convert file for the user to utilize the input device 110 to operate the computer system 100.

In addition, a plurality of predetermined codes may be set to correspond to a same object code. For example, the predetermined codes of the three motion states of input device 110 such as “moving left and right”, “moving forward” and “waving upward” in space are all set to correspond to the object code of “clicking a left button of a mouse”. Therefore, when the motion state of the input device 110 is one of “moving left and right”, “moving forward”, and “waving upward”, it represents that the user wants to perform the function of “clicking a left button of a mouse”. It is only an example of the invention, and it is not used to limit the application scope of the invention.

Thereby, in the method of the embodiment, the input device 110 may be used to imitate a conventional input device such as a keyboard, a mouse, or a joystick, and the input device 110 further may be used to play online games. For example, assuming that the interface unit 211 is a computer program, to prevent a server of an online game from viewing the interface unit 211 as cheating software, after the main body terminal 121 receives the predetermined code sent from the input device 110, the converting module 230 of the interface unit 121 is used to convert the predetermined code to a corresponding object code. Then, the converting module 230 further sends the object code to the transmission interface 130 of the main body terminal 120 to make the main body terminal 120 receive the object code via the transmission interface 130 again. Thus, the problem that the interface unit 211 may be viewed as the cheating software is solved, and the interface unit 211 may be used.

### Second Embodiment

FIG. 8 is a block diagram of a computer system according to the second embodiment of the invention. As shown in FIG. 8, a computer system 800 includes an input device 810 and a main body terminal 820. The main body terminal 820 is coupled with the input device 810 via a transmission interface 830. The input device 810 has a motion sensor 811, a receiver 813, and an interface unit 815.

The function of the input device 810 of the embodiment is the same or similar with the function of the input device 110 of the first embodiment. Therefore, it is not described hereinbelow for a concise purpose. In the embodiment, the interface unit 815 is disposed in the input device 810, and it is used to convert a predetermined code to a corresponding object code directly in the input device 810 and send the object code to the main body terminal 820 to make the computer system 800 operate according to the object code.

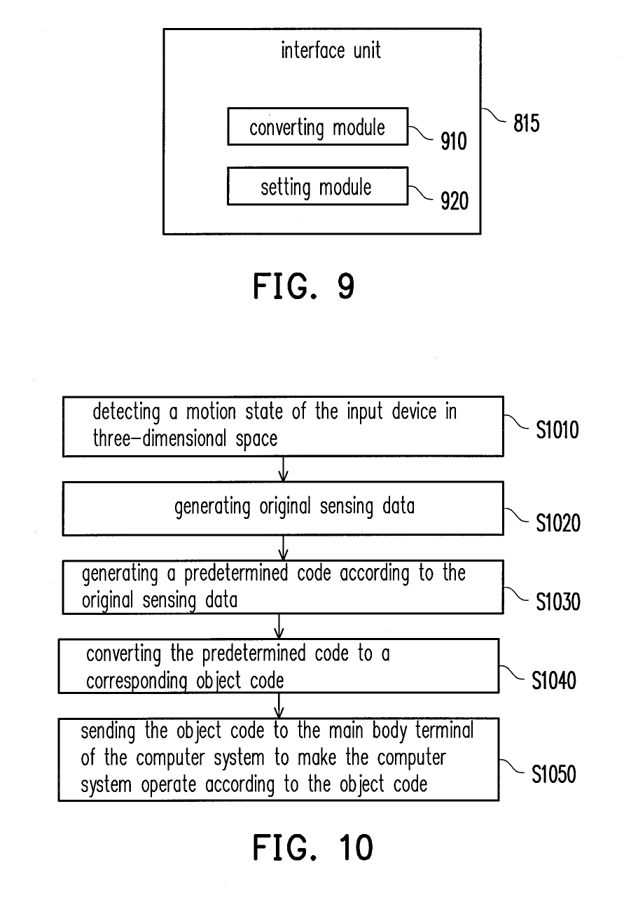

FIG. 9 is a block diagram of an interface unit according to the second embodiment of the invention. As shown in FIG. 9, in the embodiment, the interface unit 815 is, for example, a computer program installed on the input device 810. The functions of a converting module 910 and a setting module 920 of the interface unit 815 are the same or similar with the functions of the converting module 230 and the setting module 240 of the first embodiment of the invention. Therefore, they are not described hereinbelow for a concise purpose.

The steps of a method for operating the computer system in the second embodiment of the invention are described in detail hereinbelow with the computer system 800. FIG. 10 is a flowchart of the method for operating the computer system according to the second embodiment of the invention. As shown in FIG. 8, FIG. 9, and FIG. 10, first, in step S1010, the motion sensor 811 is used to detect the motion state of the input device 810 in three-dimensional space.

Then, in step S1020, the motion sensor 811 generates original sensing data (such as a coordinate position, gravitation data, and a relative position in moving) according to the motion state of the input device 810 in the three-dimensional space and transfers the original sensing data to the receiver 813.

Afterwards, as stated in step S1030, the receiver 813 generates a predetermined code according to the original sensing data. Similar with the input device 110 of the first embodiment, the input device 810 also has a plurality of function keys and a joystick input interface, such as the function keys 402 to 408 and the joystick 410 in FIG. 4A and FIG. 4B, to cooperate with the motion state of the input device 810 in the three-dimensional space to generate more usage modes.

After the predetermined code is generated, as stated in step S1040, the converting module 910 of the interface unit 815 is used to convert the predetermined code to a corresponding object code. At last, in step S1050, the object code is sent to the main body terminal 820 via the transmission interface 830 to make the computer system 800 operate according to the object code.

In the embodiment, the setting module 920 of the interface unit 815 may provide a setting interface for users to set the object code that the predetermined code of the input device 810 corresponds to.

To sum up, in the aforementioned embodiments, the motion state of the input device in the three-dimensional space is used to operate the computer system. It is more convenient, real and intuitive for users to operate a computer system. Furthermore, the users can set different motion states to operate the computer system in an initialization setting. Therefore, the invention is also adapted for application software. In another aspect, in the aforementioned embodiments, the predetermined code is provided for the input device, and the predetermined code to which the object code corresponds is set. The users can utilize the input device of the invention to imitate other conventional input devices, which is more elastic, practical, and various in usages.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for operating a computer system, comprising the steps of:
detecting a motion state of an operation terminal in three-dimensional space;
according to the motion state of the operation terminal in the three-dimensional space, generating a predetermined code at either the operation terminal or a main body terminal of the computer system; and
converting the predetermined code to a corresponding object code and sending the object code to the main body terminal of the computer system to make the computer system operate according to the object code.

2. The method for operating the computer system according to claim 1, further comprising the step of:
providing a convert file recording the predetermined code that the object code corresponds to.

3. The method for operating the computer system according to claim 1, further comprising the steps of:
providing a file list showing a plurality of data options for a user to select;
detecting the selection of the user, when the user selects via the file list; and
according to the selection of the user, automatically setting the predetermined code that the object code corresponds to.

4. The method for operating the computer system according to claim 1, wherein after the step of generating the predetermined code at the operation terminal, the method further comprises the steps of:
sending the predetermined code to the main body terminal;
converting the predetermined code to the corresponding object code;
sending the object code to a transmission interface of the main body terminal; and
receiving the object code via the transmission interface to make the computer system operate.

5. The method for operating the computer system according to claim 1, wherein the step of detecting the motion state of the operation terminal in the three-dimensional space comprises the steps of:
utilizing a motion sensor to detect the motion state of the operation terminal in the three-dimensional space and generating corresponding original sensing data.

6. The method for operating the computer system according to claim 5, wherein the step of generating the predetermined code comprises the steps of:
transferring the original sensing data to the main body terminal and generating the predetermined code according to the original sensing data.

7. The method for operating the computer system according to claim 1, wherein the operation terminal has a plurality of function keys and a joystick input interface, and the function keys and the joystick input interface have corresponding predetermined codes, respectively.

8. An input device comprising:
a motion sensor for detecting a motion state of the input device in three-dimensional space to output original sensing data;
a receiver, coupled with a main body terminal of a computer system, for receiving the original sensing data and generating a corresponding predetermined code according to the original sensing data; and
an interface unit for converting the predetermined code to a corresponding object code and sending the object code to the main body terminal of the computer system to make the computer system operate according to the object code.

9. The input device according to claim 8, wherein the interface unit comprises:
a converting module for converting the predetermined code to the corresponding object code; and
a setting module for receiving operation of a user to change the predetermined code that the object code corresponds to, providing a file list showing a plurality of data options for the user to select, and automatically setting the predetermined code to which the object code corresponds according to the selection of the user.

10. A computer system comprising:
an input device determining a motion state of the input device in three-dimensional space to output either original sensing data or a predetermined code; and
a main body terminal coupled with the input device via a transmission interface, the main body terminal including:
an interface unit receiving either the original sensing data or the predetermined code sent from the input device via the transmission interface to covert the original sensing data or the predetermined code to a corresponding object code to make the computer system operate.

11. The computer system according to claim 10, wherein the input device comprises:
a motion sensor for detecting the motion state of the input device in the three-dimensional space-to output the original sensing data; and
a receiver for directly transferring the original sensing data to the main body terminal.

12. The computer system according to claim 11, wherein the receiver generates the corresponding predetermined code according to the original sensing data and sends the predetermined code to the main body terminal.

13. The computer system according to claim 10, wherein the interface unit comprises:
a collecting module for receiving either the original sensing data or the predetermined code transferred from the input device;
a coding module for coding the original sensing data to generate the predetermined code;
a converting module for converting the predetermined code to the corresponding object code; and
a setting module for receiving operation of a user to change the predetermined code that the object code corresponds to, providing a file list showing a plurality of data options for the user to select, and automatically setting the predetermined code to which the object code corresponds according to the selection of the user.
